(19) United States
(12) Patent Application Publication
(10) Pub. No.: US 2012/0191263 A1
(43) Pub. Date: Jul. 26, 2012

(54) ELECTRIC POWER MANAGEMENT SYSTEM

(75) Inventor: Kenji Kuniyosi, Osaka (JP)

(73) Assignee: Panasonic Corporation, Osaka (JP)

(21) Appl. No.: 13/498,472

(22) PCT Filed: Sep. 6, 2010
(86) PCT No.: PCT/IB10/02225

§ 371 Date: Mar. 27, 2012

(30) Foreign Application Priority Data
Sep. 29, 2009 (JP) 2009-225068

(51) Int. Cl. G05F 5/00

(52) U.S. Cl. 700/286

(57) ABSTRACT

An electric power management system includes a power meter connected to a power system of a commercial power source and a power conditioner connected to the power meter, a power generating device and an electric appliance. The power meter and the power conditioner are configured to exchange power information through a communications part at the side of the power meter.

### FIELD OF THE INVENTION

The present invention relates to an electric power management system that includes a power conditioner through which the electric power generated by a power generation apparatus, e.g., a photovoltaic power generation apparatus, is used in association with the electric power generated by an electric power system of a commercial power source.

### BACKGROUND OF THE INVENTION

In recent years, the number of houses and offices equipped with a photovoltaic power generation apparatus (or a solar cell) tends to increase. The solar cell has power generation characteristics of generating an increased amount of electric power as the illuminance of sunlight grows higher, generating a reduced amount of electric power as the illuminance of sunlight becomes lower due to the rainy weather or other causes and stopping power generation at the nighttime when there is no sunlight. For that reason, there are many cases where the power generation pattern is not consistent with the power consumption pattern in houses or other places. Further, it is often the case that the generated power amount becomes excessively smaller than the consumed power amount. Accordingly, even if a house is equipped with a solar cell, the house is usually connected to an electric power system of a commercial power source so that, when the generated power amount is insufficient, the deficient electric power can be inputted (supplied) or bought from the commercial power source.

The electric power generated by the solar cell differs in nature from the electric power of the commercial power source. In light of this, the electric power generated by the solar cell is converted, by a power conditioner including an inverter and the like, to an electric power having the same nature as that of the alternating current power of the commercial power source and is used in association with the electric power system of the commercial power source. This makes it possible to use, in combination, the electric power generated by the solar cell in a house or other places and the electric power of the commercial power source.

In other words, the power conditioner is a device for converting the electric power generated by the solar cell so as to be made consistent with the electric power of the commercial power source in a voltage, a frequency and a phase and consequently using the electric power generated by the solar cell in association with the electric power of the commercial power source. One example of the power conditioner is described in Patent document 1.

The power conditioner described in Patent document 1 is connected to a commercial power source and a solar cell for supplying electric power, and an electric appliance consuming the electric power. The power conditioner is configured such that the electric power generated by the solar cell is supplied to the electric appliance in association with the electric power of the commercial power source through the use of an inverter. The electric power of the commercial power source can also be supplied to the electric appliance through a switching device formed of a semiconductor. If the amount of the electric power generated by the solar cell is enough to provide the electric power consumed by the electric appliance, the switching device is opened to supply only the electric power generated by the solar cell to the electric appliance. On the other hand, if the amount of the electric power generated by the solar cell is insufficient, the switching device is closed to supply the electric power generated by the solar cell in association with the electric power of the commercial power source to the electric appliance.

Patent document 1: Japanese Patent No. 2503402

In general, the user of a solar cell is highly interested in the trend of the electric power generated by the solar cell. Thus the user wishes to easily check out the various electric power information including not only the amount of the electric power generated by the solar cell but also the amount of the electric power inputted (supplied) from the commercial power source and the amount of the electric power consumed by the electric appliance and the like.

In view of this, it may be considerable to provide the power conditioner to collect the amount of the electric power generated by the solar cell and the amount of the electric power consumed by the electric appliance and to collect, from a power meter, the accurate amount of the electric power inputted (supplied) from and outputted (reversely supplied) to the commercial power source, so that the user can check out the various kinds of electric power information.

However, the power conditioner is usually installed in an indoor region from the terms of the enhanced installation environment and the user's convenience in operation, while the power meter is installed in an outdoor region for the purpose of meter reading. It is not easy for the power conditioner installed in the indoor region to effectively collect the amount of the electric power measured by the power meter installed in the outdoor region.

### SUMMARY OF THE INVENTION

In view of the above, the present invention provides an electric power management system capable of easily performing, by using a power conditioner, a centralized management of various kinds of information including the information on the amount of electric power measured by a power meter connected to an electric power system of a commercial power source.

In accordance with an embodiment of the present invention, there is provided an electric power management system, including: a power meter connected to a power system of a commercial power source; and a power conditioner connected to the power meter, a power generating device and an electric appliance. The power meter and the power conditioner exchange power information through a communications part at a side of the power meter.

In the electric power management system described above, the power meter may be connected to the power system of the commercial power source to acquire power information from an electric power inputted from the power system and an electric power outputted to the power system. Further, the power conditioner may be configured to collect power information of the power generating device; power information of the electric appliance; and the power information of the electric power inputted from the power system and the power information of the electric power outputted to the power system, which are acquired from the power meter through the communications part at the side of the power meter, and to manage the electric power inputted from the power system and the electric power outputted to the power system, based on the collected power information.

In general, the power meter is arranged outside a house or a building and the power conditioner is arranged inside the house or the building. This makes it difficult for the power conditioner to acquire the power information such as the amount of electric power measured by the power meter.

With such configuration, the power meter and the power conditioner can make communications with each other through the communications part at the side of the power meter. Through the communications with the power meter, the power conditioner can easily acquire from the power meter the power information on the voltage, current, electric power amount, frequency and phase of the electric power inputted from or outputted to the commercial power source, which is measured by the power meter. As a result, the power conditioner can accurately acquire the power information on the electric power inputted from or outputted to the commercial power source, which does not entail the loss caused by outdoor wiring lines and coincides with the meter reading value of a power company. This enables the electric power management system to accurately and properly manage the electric power.

In addition, the power information on the electric power generated by the power generating devices, the power information on the electric power consumed by the respective electric appliances and the power information on the electric power measured by the power meter are collected in the power conditioner. It is therefore possible to appropriately carry out the electric power management of the entire power supply system based on the power information stated above. As a result, it is possible for the power conditioner to accurately perform the centralized power management including the management of the input and output of the electric power to and from the power system. This makes it possible to increase the utility value of the electric power management system.

Further, the electric power management system described above may further include a display device for acquiring the power information collected in the power conditioner from the power conditioner through a communications part at a side of the display device and visually displaying the acquired power information on a display unit.

With such configuration, the display device can acquire the power information collected in the power conditioner through the communications part at the side of the display device and can visibly display the display information generated from the acquired power information in the form of an image such as a numerical number or a graph. This makes it easy to check out the power information collected in the power conditioner. Accordingly, it is possible to enhance the utility value of the electric power management system.

Further, the communications part at the side of the display device may include a subordinate extension unit provided in the power conditioner to transmit the power information collected in the power conditioner and a communications unit provided in the display device to receive the power information transmitted from the subordinate extension unit.

With such configuration, it is possible to easily transfer the power information of the power conditioner to the display device, by providing the subordinate extension unit in the power conditioner and the communications unit in the display device and enabling communications between the subordinate extension unit and the communications unit.

Further, the communications part at the side of the power meter may include a first extension unit provided in the power meter to transmit the power information acquired from the power meter and a second extension unit provided in the power conditioner to receive the power information transmitted from the first extension unit.

With such configuration, it is possible for the first extension unit of the power meter and the second extension unit of the power conditioner to mutually transfer the power information of the power meter and the power information of the power conditioner, by providing the first extension unit and the second extension unit and enabling communications between the first extension unit and the second extension unit.

Further, the second extension unit of the power conditioner may serve as the subordinate extension unit of the corresponding power conditioner.

With such configuration, the communications between the power meter and the power conditioner and the communications between the power conditioner and the display device can be performed in the same communications method. In other words, the communications methods of the first communications part and the second communications part are unified into a single method. This makes it possible to simplify the structure of the subordinate extension unit of the power conditioner included in the first communications part and the second communications part. This also helps reduce the effort required in installing communications equipment.

Further, the power meter may further include a device communicatively connected to a system server for managing the power system of the commercial power source and configured to acquire the power information collected in the power conditioner through the communications part at the side of the power meter and transfer the acquired power information to the system server.

With such configuration, the system server managing the power system can acquire the power information of the power conditioner and can estimate the power consumption trend using the power management data contained in the power information thus acquired. For example, if the system server is allowed to manage the power system based on the power consumption trend, it is possible to further stabilize the electric power of the power system and to increase the utility value of the electric power management system.

Further, the power conditioner may be configured to acquire power information held by the system server through the power meter and to manage the acquired power information.

With such configuration, the power conditioner acquires the power information of the system server from the power meter and manages the power information together with the electric power inputted from and outputted to the power system. As a result, for example, if the power information of the system server contains the information for stabilization of the system, the power conditioner can adjust the electric power inputted to and outputted from the commercial power source, thereby stabilizing the power system. If the power information of the system server contains the billing information, it is possible to perform the management of electric power according to the charged fare.

### BRIEF DESCRIPTION OF THE DRAWINGS

The objects and features of the present invention will become apparent from the following description of preferred embodiments given in conjunction with the accompanying drawings, in which:

FIG. 1 is a functional block diagram showing the schematic configuration of a power supply system which forms a part of an electric power management system according to a first embodiment of the present invention;

FIG. 2 is a configuration view showing the specific configuration of the electric power management system of the first embodiment;

FIGS. 3A and 3B are views schematically showing a connection configuration that enables communications between a power meter, a power conditioner and a display device unit employed in the electric power management system of the first embodiment;

FIGS. 4A and 4B are views schematically showing a connection configuration that enables communications between a power meter, a power conditioner and a display device unit employed in an electric power management system according to a second embodiment;

FIG. 5 is a configuration view showing one example of a subordinate extension unit of the power conditioner employed in the electric power management systems of the first and second embodiments;

FIG. 6 is a view schematically showing one example of the connection for communications between the power meter, the power conditioner and the display device unit employed in the electric power management systems of the first and second embodiments; and

FIG. 7 is a view schematically showing another example of the connection for communications between the power meter, the power conditioner and the display device unit employed in the electric power management systems of the first and second embodiments.

### DETAILED DESCRIPTION OF THE PREFERRED EMBODIMENTS

Hereinafter, embodiments of the present invention will be described with reference to the accompanying drawings which form a part hereof. Throughout the drawings, like reference numerals will be given to like parts, and redundant description thereof will be omitted.

### First Embodiment

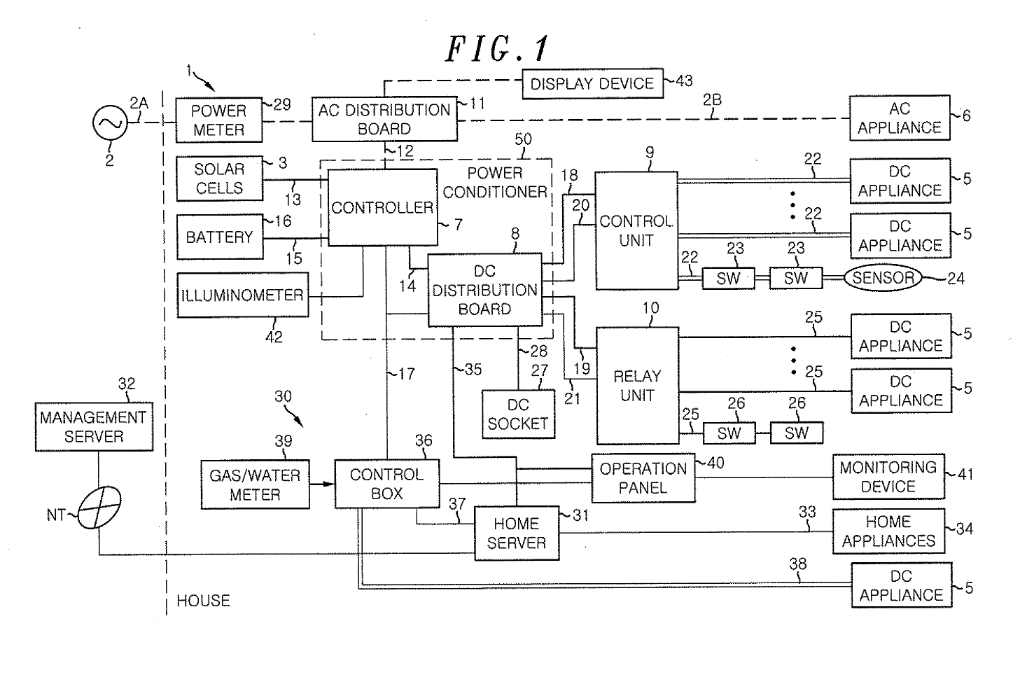

An electric power management system in accordance with a first embodiment of the present invention will be described in detail. FIG. 1 is a functional block diagram showing a schematic configuration of a power supply system 1 which forms a part of the electric power management system.

As shown in FIG. 1, a house is provided with the power supply system 1 for supplying an electric power to a variety of home appliances (such as an illuminating device, an air conditioner, an electrical device and an audiovisual device). The power supply system 1 supplies the electric power of a home-use commercial AC source (or a commercial power source) 2 and further supplies the electric power from a solar cell 3 generating electric power with the sunlight to operate various kinds of appliances. The power supply system 1 supplies the electric power to not only DC appliances 5 operating with the DC power inputted from a DC power supply but also an AC appliance 6 operating with the AC power inputted from an AC power source 2. In the following description, a single house will be taken as an example of the building to which the present invention is applied. However, it is not limited thereto. For example, the present invention may also be applied to building or collective housings such as an office, a shopping arcade and a factory.

The power supply system 1 is provided with a power conditioner 50 including a controller 7 and a DC distribution board (in which a DC breaker is arranged) 8. The power supply system 1 is further provided with a control unit 9 and a relay unit 10 for controlling operations of the DC appliances 5 installed in the house.

An AC distribution board 11 for dividing the AC power is connected to the controller 7 through an AC power line 12. The controller 7 is connected to the commercial AC power source 2 via the AC distribution board 11 and is connected to the solar cell 3 via a DC power line 13. The controller 7 receives AC power from the AC distribution board 11 and receives DC power from the solar cell 3. The controller 7 converts the AC power and the DC power to specified DC power to be used as the source power of the appliances. The controller 7 outputs the converted DC power to the DC distribution board 8 through a DC power line 14 or to a battery 16 through a DC power line 15 to thereby store the DC power in the battery 16. Not only does the controller 7 receive the AC power from the AC distribution board 11 but also the controller 7 can convert the electric power from the solar cell 3 or the battery 16 to an AC power and supply the AC power to the AC distribution board 11. The controller 7 exchanges data with the DC distribution board 8 through a signal line 17. An illuminometer 42 for measuring the illuminance of the light irradiated on the solar cell 3 is connected to the controller 7. Illuminance information as environmental information such as an illuminance value is transmitted from the illuminometer 42 to the controller 7.

The DC distribution board 8 is a kind of breaker for the DC power. The DC distribution board 8 divides the DC power inputted from the controller 7 and outputs the divided DC power to the control unit 9 through a DC power line 18 or to the relay unit 10 through a DC power line 19. The DC distribution board 8 exchanges data with the control unit 9 through a signal line 20 or with the relay unit 10 through a signal line 21.

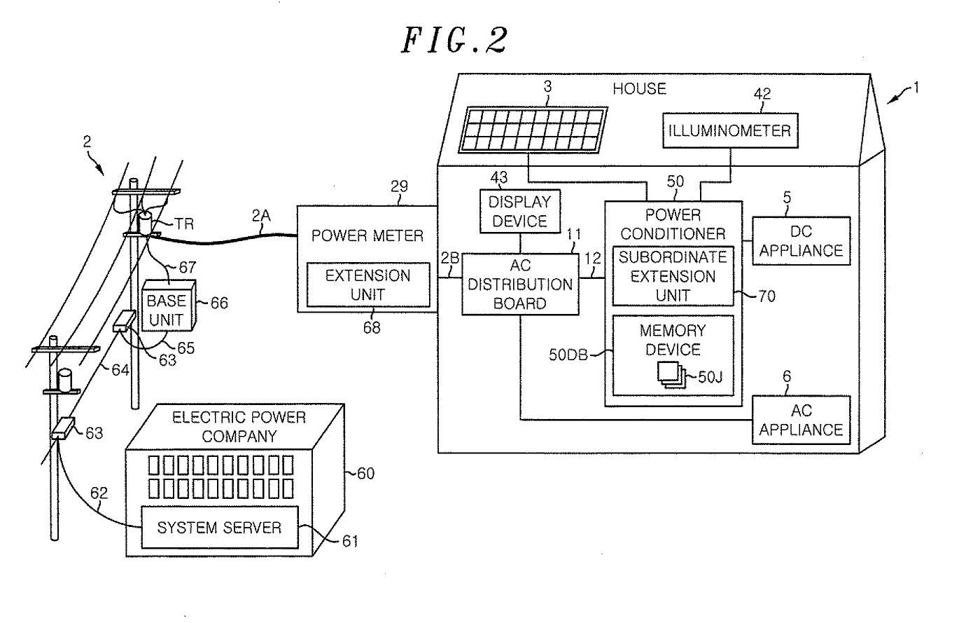

In the power supply system 1, the power conditioner 50 for coordinating power management in the power supply system 1 is configured in such a fashion as to include the controller 7 and the DC distribution board 8. The power conditioner 50 is provided with a memory device 50DB (see FIG. 2) storing various kinds of information. In other words, the power conditioner 50 is connected to the AC distribution board 11, the solar cell 3, the battery 16 and the DC appliances 5 through individual power lines. Based on this, the power conditioner 50 is configured to measure the power information on the AC power supplied or reversely supplied (inputted or outputted) to or from the AC power source 2 and to measure the power information (power generation information) on the electric power generated by the solar cell 3 and the power information on the DC power consumed in the DC appliances 5.

Examples of the power information on the AC power include a voltage, a current, an electric power amount, a frequency and a phase. Examples of the power information on the DC power include a voltage, a current and an electric power amount. The power information selected from them is measured in the power conditioner 50. In the power conditioner 50, the power information on the AC power source 2 and the power information of the solar cell 3 and the DC appliances 5 thus measured are collected in the memory device 50DB as power-related information 50J (see FIG. 2).

A plurality of DC appliances 5 is connected to the control unit 9. The DC appliances 5 are connected to the control unit 9 through respective DC supply lines 22 through which both DC power and data can be transmitted by using the same wiring. Communications signals for transmitting data with a high-frequency carrier wave are overlapped with the DC power to be supplied to the DC appliances 5 and are transmitted through the respective DC supply lines 22. For example, both the electric power and the data are transmitted to each of the DC appliances 5 by using a pair of lines. The control unit 9 receives the DC power for the DC appliances 5 through a DC power line 18 and determines how to control which of the DC appliances 5 based on an operation instruction obtained from the DC distribution board 8 through a signal line 20. Then, the control unit 9 outputs the DC power and the operation instruction to the designated DC appliances 5 through the corresponding DC supply lines 22, thereby controlling the operations of the DC appliances 5.

Switches 23 that are manipulated when the operations of the DC appliances 5 are switched over are connected to the control unit 9 through a DC supply line 22. In addition, a sensor 24 for detecting radio waves transmitted from, e.g., an infrared remote controller is connected to the control unit 9 through the DC supply line 22. Accordingly, the DC appliances 5 are controlled by transmitting communications signals through the DC supply lines 22 in response not only to the operation instruction from the DC distribution board 8 but also to the manipulation of the switches 23 and the detection in the sensor 24.

Further, the control unit 9 can transfer the power information on the electric power amounts consumed by the respective DC appliances 5 and the like to the power conditioner 50 (or the DC distribution board 8) through a signal line 20. As a result, the power information of the respective DC appliances 5 connected to the control unit 9 is collected in the power conditioner 50. Alternatively, the DC appliances 5 connected to the control unit 9 through the respective DC supply lines 22 can transfer the power information on the electric power amounts detected by themselves and the like to the power conditioner 50 through the control unit 9 so that the information can be collected in the memory device 50DB.

A plurality of DC appliances 5 is connected to the relay unit 10 through individual DC power lines 25. The relay unit 10 obtains the DC power for the DC appliances 5 through a DC power line 19, and determines which of the DC appliances 5 is to be operated based on an operation instruction obtained from the DC distribution board 8 through the signal line 21.

Further, the relay unit 10 controls the operations of the DC appliances 5 determined to be operated in such a way that relays built therein turn on and off the supply of powers through the DC power lines 25. A plurality of switches 26 for manually operating the DC appliances 5 is connected to the relay unit 10. The DC appliances 5 are controlled by manually manipulating the switches 26 to cause the relays to turn on and off the supply of powers to the DC power lines 25. The relay unit 10 can transfer the power information on the electric power amounts consumed by the respective DC appliances 5 and the like to the power conditioner 50 (or the DC distribution board 8) through the signal line 21. As a result, the power information of the respective DC appliances 5 connected to the relay unit 10 is collected in the memory device 50DB of the power conditioner 50.

In the power conditioner 50, various kinds of power information of the power supply system 1 such as the power information measured by the power conditioner 50 itself and the power information detected by the control unit 9 and the relay unit 10 are collected in the memory device 50DB as power-related information 50J. The power-related information 50J can be utilized as power management data in the power supply system 1. The power conditioner 50 can generate estimated consumption information indicating the current power consumption amount based on the power management data obtainable from the power-related information 50J.

DC sockets 27 installed in the house in the form of, e.g., a wall socket or a floor socket, are connected to the DC distribution board 8 through a DC power line 28. If the plugs (not shown) of the DC appliances 5 are inserted into the DC sockets 27, it is possible to directly supply the DC power to the DC appliances 5.

A power meter 29 capable of remotely measuring the amount of the power used by the commercial AC power source 2 is connected between the commercial AC power source 2 and the AC distribution board 11. The power meter 29 is equipped with not only a function of remotely measuring an amount of power used by the commercial AC power source 2 but also, e.g., a power line communications (PLC) function and a wireless communications function. The power meter 29 transmits measurement results to an electric power company or the like through power line communications or wireless communications.

In the present embodiment, the communications between the power meter 29 which transfers the measurement results to the electric power company and the power company is performed as follows. Communications is performed between the power company and an electric pole through a well-known communications line. Moreover, communications is performed between the communications line and the power meter 29 by virtue of power line communications in which a lead-in power line 2A connected to a step-down transformer TR (see FIG. 2) is used as a communications medium. The power meter 29 is also connected to the power conditioner 50 via a first communications part in such a way as to make communications with each other.

A display device 43 for visually displaying the power-related information 50J managed by the power conditioner 50 is connected to the AC distribution board 11 through a second communications part. That is, in the present embodiment, the power conditioner 50 transmits the power-related information 50J to be displayed on the display device 43. The display device 43 receives the power-related information 50J transmitted from the power conditioner 50.

The power supply system 1 is provided with a network system 30 that makes it possible to control various kinds of home appliances through network communications. The network system 30 includes a home server 31 that functions as a control unit thereof. The home server 31 is connected to an outdoor management server 32 through an external communications network NT such as the Internet and is also connected to home appliances 34 through a signal line 33. The home server 31 is operated by the DC power supplied from the DC distribution board 8 through a DC power line 35.

A control box 36 for managing the operations of various kinds of home appliances controlled through network communications is connected to the home server 31 through a signal line 37. The control box 36 is connected to the controller 7 and the DC distribution board 8 through a signal line 17. The control box 36 is capable of directly controlling the DC appliances 5 through a DC supply line 38. A gas/tap water meter 39 capable of remotely measuring, e.g., the amounts of gas and tap water used, is connected to the control box 36. The control box 36 is connected to an operation panel 40 of the network system 30. A monitoring device 41 formed of, e.g., a door phone extension unit, a sensor or a camera, is connected to the operation panel 40.

If an operation instruction to operate the various kinds of home appliances is inputted through the external communications network NT, the home server 31 notifies the control box 36 of the operation instruction and operates the control box 36 so that the home appliances can be operated based on the operation instruction. Moreover, the home server 31 can provide various kinds of information obtained from the gas/tap water meter 39 to the management server 32 through the external communications network NT. If an abnormality detected by the monitoring device 41 is notified to the home server 31 through the operation panel 40, the home server 31 provides the information on the detected abnormality to the management server 32 through the external communications network NT.

Next, the specific configuration of the electric power management system in accordance with the present embodiment will be described with reference to FIG. 2. FIG. 2 is a configuration view specifically showing the configuration of the electric power management system.

As shown in FIG. 2, the power supply system 1 installed in a house or other places is connected through the power meter 29 to an electric power system of an AC power source 2 managed by the electric power company. In other words, a plurality of power meters 29 including the ones not showing in FIG. 2 is connected to the power system of the AC power source 2 through individual lead-in power lines 2A extending from a step-down transformer TR. The power meter 29 is provided with an extension unit 68 having a function of making power line communications with a base unit 66 installed on an electric pole. The base unit 66 on the electric pole and the extension unit 68 of the power meter 29 are connected to each other through a power signal line 67 and a lead-in power line 2A with the step-down transformer TR interposed therebetween. In other words, the lead-in power line 2A transmits AC power between the power system and the power meter 29 and serves as a communications medium through which a power line communications signal is transmitted between the base unit 66 and the extension unit 68 of the power meter 29.

The power company 60 has a dedicated communications line 64 used in remotely reading the amount of power measured by the power meter 29. The communications line 64 is similar in form to the wiring line of the power system of the AC power source 2. The base unit 66 is communicatively connected to the communications line 64 through a communications line 65 and a media converter 63. In other words, the base unit 66 enables communications signals to be exchanged between the communications line 64 and the power signal line 67 and converts the type of received signals into the type of transmitted signals and vice versa. A meter reading server (not shown) of the power company 60 is communicatively connected to the communications line 64. Thus, the meter reading server can perform a so-called remote meter reading that acquires the amount of power (the meter reading results) measured by the power meter 29 communicatively connected through the communications line 64 through communications and records the amount of power thus acquired.

Further, the power company 60 has a system server 61 for managing the information on the AC power flowing through the power system of a commercial power source. The system server 61 is communicatively connected to the communications line 64 through a communications line 62 and a media converter 63. Accordingly, the system server 61 of the power company 60 is communicatively connected to the power meter 29, connected to the communications line 64, through the communications line 64.

For example, the system server 61 collects and manages the power information such as the power generation amounts of a plurality of power plants held by the power company 60, the power consumption amounts of the respective power systems distinguished for respective areas, and the power amounts reversely supplied from the solar cell 3 or the like to the power systems. The system server 61 enables the power company 60 to use the information in managing the power systems of the commercial power source. In other words, the power meter 29 communicatively connected to the system server 61 can transmit the power information to the system server 61 and can receive the power information from the system server 61.

In the electric power management system of the present embodiment, the power meter 29 and the power conditioner 50 are communicatively connected to each other via a communications part at a side of the power meter (hereinafter referred to as “first communications part”).

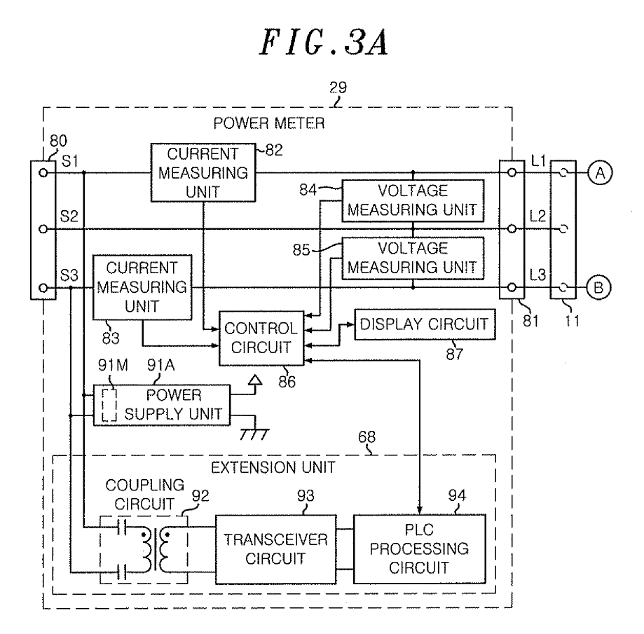

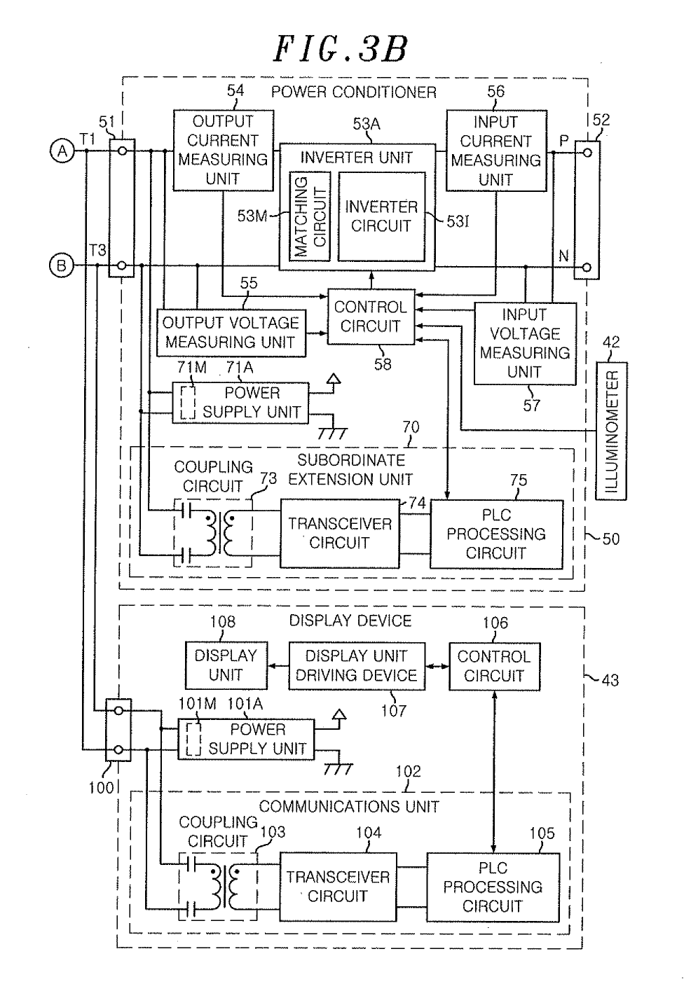

Next, the first communications part communicatively interconnecting the power meter 29 and the power conditioner 50 and the communications part at a side of the display device (hereinafter referred to as “second communications part”) communicatively interconnecting the power conditioner and the display device 43 will be described with reference to FIGS. 3A and 3B. FIGS. 3A and 3B are schematic views showing a connection configuration that enables communications between the power meter 29 and the power conditioner 50 and between the power conditioner 50 and the display device 43.

As shown in FIGS. 3A and 3B, the power meter 29 is a meter for measuring the current, voltage and power amount of the single-phase three-wire AC power inputted and outputted between the power meter 29 and the power system of the commercial power source. Further, the power meter 29 includes a terminal block 80 connected to the power system of the commercial power source and a terminal block 81 connected to the power conditioner 50 via an AC distribution board 11. The terminal block 80 is provided with terminals S1, S2 and S3 and the terminal block 81 is provided with terminals L1, L2 and L3. The terminal S1 and the terminal L1 are connected to each other. The terminal S2 and the terminal L2 are connected to each other. The terminal S3 and the terminal L3 are connected to each other.

In the present embodiment, a single-phase AC power is supplied to the terminals Si and S3. The terminal S2 becomes a neutral line. Thus, the power meter 29 is provided with a current measuring unit 82 for measuring the current flowing through the terminal S1, a current measuring unit 83 for measuring the current flowing through the terminal S3, a voltage measuring unit 84 for measuring the voltage between the terminals S1 and S2 and a voltage measuring unit 85 for measuring the voltage between the terminals S3 and S2. Signals indicating the current values measured by the current measuring units 82 and 83 and signals indicating the voltage values measured by the voltage measuring units 84 and 85 are inputted to a control circuit 86 so that the control circuit 86 can perform calculation of a power amount or the like.

The control circuit 86 transmits a signal indicating the calculated power amount to a display circuit 87 so that the display circuit 87 can display the calculated power amount. The display circuit 87 includes a display unit capable of visually displaying information. The power amount received from the control circuit 86 and other information are displayed on the display unit in a visible form such as numerical numbers.

The power meter 29 is provided with an extension unit 68 for making communications, through power lines connected to the terminal block 80 and the terminal block 81, with other units connected to the power lines.

The extension unit 68 is configured to perform power line communications using the power lines as a communications medium. The extension unit 68 includes: a coupling circuit 92 that uses the power lines connected to the terminals S1 and S3 as the communications medium, the coupling circuit 92 connected to the communications medium; a transceiver circuit 93 for transmitting and receiving a modulated signal to and from the coupling circuit 92; and a power line communications processing circuit 94 for transmitting and receiving communications signal information to and from the transceiver circuit 93. A control circuit 86 is connected to the power line communications processing circuit 94, so that signals through power line communications are transmitted and received therebetween.

Accordingly, the extension unit 68 acquires a power line communications signal, which is overlapped with the electric power and received through the power lines (the terminals S1 and S3), and transfers the acquired signal to the control circuit 86. Furthermore, the extension unit 68 converts the signal outputted from the control circuit 86 to a power line communications signal and transmits the power line communications signal through the power lines (the terminals S1 and S3) by overlapping same with the electric power. In order to efficiently overlap the power line communications signal with the electric power, it is preferred that the impedance of the power lines, i.e., the impedance between the terminals S1 and S3, in a communications frequency band used for power line communications is kept high.

Further, the power meter 29 is provided with a power supply unit 91A for supplying the electric power required to drive the control circuit 86 and so forth. The power supply unit 91A is connected to the terminals S1 and 33. The power supply unit 91A converts the electric power inputted from the terminals S1 and S3 to the electric power required to drive the control circuit 86 and so forth. In general, a capacitor is connected to an input circuit of the power supply unit 91A to prevent noises from leaking to the outside. The capacitor serves to reduce the impedance of the power lines connected to the input circuit of the power supply unit 91A, i.e., the impedance within a communications frequency band used for power line communications.

In the present embodiment, therefore, a matching circuit 91M, i.e., a so-called impedance booster, for avoiding reduction of the impedance of the power lines within a power line communications frequency band is provided between the power line and the input circuit of the power supply unit 91A so that the power line communications can be efficiently performed by the extension unit 68 of the power meter 29. As a result, the power supply unit 91A can be connected to the terminals Si and S3 while restraining reduction of the impedance between the terminals S1 and S3 within a power line communications frequency band.

The terminal block 81 of the power meter 29 is connected to the AC distribution board 11 through the terminals L1, L2 and L3. The AC distribution board 11 is connected to the power conditioner 50 through a terminal T1 corresponding to the terminal L1 of the terminal block 81 and a terminal T3 corresponding to the terminal L3 of the terminal block 81.

The power conditioner 50 converts the AC power inputted from an AC terminal block 51 to DC power and outputs the DC power to a DC terminal block 52. Moreover, the power conditioner 50 has a function of converting the DC power inputted from the DC terminal block 52 to AC power and outputting the AC power to the AC terminal block 51. The AC power flowing through the terminals T1 and T3 of the AC terminal block 51 of the power conditioner 50 is inputted to an inverter unit 53A after the current value thereof is measured by an output current measuring unit 54 and the voltage value thereof is measured by an output voltage measuring unit 55.

The inverter unit 53A includes an inverter circuit 531 for performing AC-DC conversion or DC-AC conversion of the electric power and a matching circuit 53M for restraining reduction of the impedance between the terminals T1 and T3. In order to reduce the impedance of the power lines connected to the inverter circuit 53I, the matching circuit 53M is arranged between the inverter circuit 53I and the terminals T1 and T3. The inverter unit 53A is connected to terminals P and N of the DC terminal block 52. The current value of the DC power flowing through the DC terminal block 52 is measured by an input current measuring unit 56 and the voltage value thereof is measured by an input voltage measuring unit 57.

The current value measured by the output current measuring unit 54, the voltage value measured by the output voltage measuring unit 55, the current value measured by the input current measuring unit 56 and the voltage value measured by the input voltage measuring unit 57 are inputted to a control circuit 58. The control circuit 58 controls the DC-AC conversion or the AC-DC conversion of the electric power performed in the power conditioner 50 by setting various kinds of information on the power conversion with respect to the inverter unit 53A.

The power conditioner 50 is provided with a subordinate extension unit 70 for making communications, through power lines connected to the AC terminal block 51, with other units connected to the power lines. The subordinate extension unit 70 is configured to perform power line communications using the power lines as a communications medium. The subordinate extension unit 70 has the same configuration as that of the extension unit 68 of the power meter 29.

More specifically, the subordinate extension unit 70 includes: a coupling circuit 73 that uses the power lines connected to the terminals T1 and T3 as the communications medium, the coupling circuit 73 connected to the communications medium; a transceiver circuit 74 for transmitting and receiving a modulated signal to and from the coupling circuit 73; and a power line communications processing circuit 75 for transmitting and receiving communications signal information to and from the transceiver circuit 74. A control circuit 58 is connected to the power line communications processing circuit 75, so that signals through power line communications are transmitted and received therebetween.

Accordingly, the subordinate extension unit 70 acquires a power line communications signal, which is overlapped with the electric power and received through the power lines (the terminals T1 and T3), and transfers the acquired signal to the control circuit 58. Furthermore, the subordinate extension unit 70 converts the signal outputted from the control circuit 58 to a power line communications signal and transmits the power line communications signal through the power lines (the terminals T1 and T3) by overlapping same with the electric power.

In order to efficiently overlap the power line communications signal with the electric power, it is preferred as in the extension unit 68 of the power meter 29 that the impedance of the power lines, i.e., the impedance between the terminals T1 and T3, in a communications frequency band used for power line communications is kept high.

Further, the power conditioner 50 is provided with a power supply unit 71A for supplying the electric power required to drive the control circuit 58 and so forth. The power supply unit 71A is connected to the terminals T1 and T3. The power supply unit 71A converts the electric power inputted from the terminals T1 and T3 to the electric power required to drive the control circuit 58 and so forth. Similar to the power supply unit 91A of the power meter 29, the power supply unit 71A serves to reduce the impedance of the power lines connected to the input circuit thereof, i.e., the impedance within a communications frequency band used for power line communications. In the power supply unit 71A, therefore, a matching circuit 71M, i.e., a so-called impedance booster, for avoiding reduction of the impedance of the power lines within a power line communications frequency band is provided between the power line and the input circuit of the power supply unit 71A so that the power line communications can be efficiently performed by the subordinate extension unit 70. As a result, the power supply unit 71A can be connected to the terminals T1 and T3 while restraining reduction of the impedance between the terminals T1 and T3.

In the present embodiment, the extension unit 68 of the power meter 29 and the subordinate extension unit 70 of the power conditioner 50 make up a power line communications unit, i.e., a first communications part, that enables the power meter 29 and the power conditioner 50 to make power line communications with each other.

The AC distribution board 11 is connected to the display device 43 through the terminals T1 and T3. The display device 43 performs visible display using the signal acquired through power line communications. The display device 43 includes a terminal block 100 connected to the AC distribution board 11 and the power conditioner 50 through the power lines. The display device 43 includes a communications unit 102 for making communications, through power lines connected to the terminal block 100, with other units connected to the power lines. The communications unit 102 is configured to make power line communications using the power lines as a communications medium. The configuration of the communications unit 102 is the same as the configuration of the extension unit 68 of the power meter 29 and the configuration of the subordinate extension unit 70 of the power conditioner 50.

In other words, the communications unit 102 includes: a coupling circuit 103 that uses the power lines connected to the terminals T1 and T3 as the communications medium, the coupling circuit 103 connected to the communications medium; a transceiver circuit 104 for transmitting and receiving a modulated signal to and from the coupling circuit 103; and a power line communications processing circuit 105 for transmitting and receiving communications signal information to and from the transceiver circuit 104. A control circuit 106 is connected to the power line communications processing circuit 105, so that signals through power lines communications are transmitted and received therebetween.

Accordingly, the communications unit 102 acquires a power line communications signal, which is overlapped with the electric power and received through the power lines (the terminals T1 and T3), and transfers the acquired signal to the control circuit 106. Furthermore, the communications unit 102 converts the signal outputted from the control circuit 106 to a power line communications signal and transmits the power line communications signal through the power lines (the terminals T1 and T3) by overlapping same with the electric power. In order to efficiently overlap the power line communications signal with the electric power, it is preferred as in the extension unit 68 of the power meter 29 and the subordinate extension unit 70 of the power conditioner 50 that the impedance of the power lines, i.e., the impedance between the terminals T1 and T3, in a communications frequency band used for power line communications is kept high.

The display device 43 further includes a display unit driving device 107 connected to the control circuit 106 and a display unit 108 driven and controlled by the display unit driving device 107. The control circuit 106 generates a control signal to be visibly displayed on the display unit 108 by processing the signal transmitted from the communications unit 102 and transfers the control signal to the display unit driving device 107. Responsive to the control signal transferred from the control circuit 106, the display unit driving device 107 generates a drive signal for driving the display unit 108 and transfers the drive signal to the display unit 108. In response to the drive signal transferred from the display unit driving device 107, the display unit 108 displays the visible information such as a numerical number and a graph on the display surface thereof.

The display device 43 is provided with a power supply unit 101A for supplying the electric power required to drive the control circuit 106 and so forth. The power supply unit 101A is connected to the terminals T1 and T3. The power supply unit 101A converts the electric power inputted from the terminals T1 and T3 to the electric power required to drive the control circuit 106 and so forth. Similar to the power supply unit 91A of the power meter 29 and the power supply unit 71A of the power conditioner 50, the power supply unit 101A serves to reduce the impedance of the power lines connected to the input circuit thereof, i.e., the impedance within a communications frequency band used for power line communications.

In the power supply unit 101A, therefore, a matching circuit 101, i.e., a so-called impedance booster, for avoiding reduction of the impedance of the power lines within a power line communications frequency band is provided between the power line and the input circuit of the power supply unit 101A so that the power line communications can be efficiently performed by the communications unit 102. As a result, the power supply unit 101A can be connected to the terminals T1 and T3 while restraining reduction of the impedance between the terminals T1 and T3 within a power line communications frequency band.

In the present embodiment, the subordinate extension unit 70 of the power conditioner 50 and the communications unit 102 of the display device 43 make up a power line communications unit, i.e., a second communications part, that enables the power conditioner 50 and the display device 43 to make power line communications with each other.

With such configuration, the extension unit 68 of the power meter 29 and the subordinate extension unit 70 of the power conditioner 50 are connected to each other through a pair of power lines including the power line connected to the terminals S1 and T1 and the power line connected to the terminals S3 and T3, so that they can make power line communications with each other. The subordinate extension unit 70 of the power conditioner 50 and the communications unit 102 of the display device 43 are connected to each other through a pair of power lines including the power line connected to the terminal T1 and the power line connected to the terminal T3, so that they can make power line communications with each other.

Further, the subordinate extension unit 70 of the power conditioner 50 has two communications targets, i.e., the extension unit 68 of the power meter 29 and the communications unit 102 of the display device 43. By allowing the communications targets to have different communications frequencies or by allowing the communications targets to have identification information that can identify the communications targets, it is possible for the subordinate extension unit 70 of the power conditioner 50 to make independent communications with selected one of the communications targets.

As a result, the power information of the power meter 29 is transferred to the power conditioner 50 through power line communications and is collected in the memory device 50DB of the power conditioner 50 as power-related information 503. The power conditioner 50 controls the power consumption amounts of the respective DC appliances 5 based on the power management data of the power-related information 503 stored in the memory device 50DB.

Consequently, the power conditioner 50 can control the AC power supplied from the commercial power source and can reversely supply the electric power generated by the solar cell 3 to the commercial power source as much as possible. In other words, the power conditioner 50 controls and manages the power consumption amount of the entire power supply system 1 based on the power-related information 503. At this time, the power conditioner 50 uses the power information of the power meter 29 coinciding with the meter reading data of the power company 60. It is therefore possible for the power conditioner 50 to more properly perform the electric power management of the entire power supply system 1.

Further, the power-related information 50J, including the power information of the power meter 29, collected in the power conditioner 50 is transferred to the display device 43 and visually displayed to a user. At this time, the power information of the power meter 29 is used to thereby display to a user the billing information on the electric power coinciding with the meter reading data of the power company 60.

Further, the power meter 29 is able to make communications with the system server 61 of the power company 60. Therefore, if the power meter 29 acquires the power-related information held by the system server 61, it is possible for the power conditioner 50 to acquire the same power-related information of the system server 61 as acquired by the power meter 29. On the contrary, the system server 61 may acquire the power-related information 50J of the power conditioner 50 through the power meter 29. As a result, the power conditioner 50 can perform the electric power management based on the power-related information of the system server 61. In addition, the power company 60 can stabilize the electric power of the power system of the commercial power source by referring to the power-related information 50J of the power conditioner 50 acquired in the system sever 61.

For example, upon acquiring the illuminance information of the illuminometer 42 from a plurality of power conditioners 50, the system server 61 can estimate the illuminance change in the information-acquired region. Moreover, the system server 61 can estimate the amount of power to be outputted to the power system of the commercial power source, based on the power generation information of the solar cell 3 stored in the power conditioner 50. This makes it possible to stabilize the power system of the commercial power source. In addition, upon acquiring the illuminance change estimation information from the system server 61, the power conditioner 50 can estimate the power generation amount of the solar cell 3. This makes it possible to appropriately perform the electric power management of the power supply system 1.

Further, for example, the system server 61 may provide the information for stabilization of the system to the power conditioner 50. In this case, the power conditioner 50 controls the input and output of the electric power between the power systems of the commercial power source based on the information for stabilization of the system thus acquired. This control is performed by reducing the power consumption of the DC appliances 5 through the cutoff of the power supply or the change of the operation mode or by not outputting the electric power generated by the solar cell 3. This also makes it possible to stabilize the power system of the commercial power source.

As described above, the electric power management system in accordance with the present embodiment can provide the following effects.

(1) In general, the power meter 29 is arranged outside a house or a building and the power conditioner 50 is arranged inside the house or the building. This makes it difficult for the power conditioner 50 to acquire the power information such as the amount of power measured by the power meter 29.

In view of this, the first communications part is provided to make communications between the power meter 29 and the power conditioner 50. As a result, the power conditioner 50 can easily acquire from the power meter 29 the power information on the electric power inputted from or outputted to the commercial power source, which is measured by the power meter 29.

(2) The power information on the electric power generated by the power generators such as the solar cell 3 and the battery 16, the power information on the electric power consumed by the respective DC appliances 5 and the power information on the electric power measured by the power meter 29 are collected in the power conditioner 50. It is therefore possible to appropriately carry out the electric power management of the entire power supply system 1 based on the power information stated above. As a result, it is possible for the power conditioner 50 to accurately perform the centralized power management including the management of the input and output of the electric power to and from the power system. This assists in enhancing the utility value of the electric power management system.

(3) The display device 43 can acquire the power information collected in the power conditioner 50 through the second communications part and can visibly display the display information generated from the acquired power information in the form of an image such as a numerical number or a graph. This makes it easy to confirm the power information collected in the power conditioner 50. Accordingly, it is possible to enhance the utility value of the electric power management system.

(4) By providing the subordinate extension unit 70 of the power conditioner 50 and the communications unit 102 of the display device 43 and enabling communications between the subordinate extension unit 70 and the communications unit 102, it is possible to easily transfer the power information of the power conditioner 50 to the display device 43.

(5) The communications between the power conditioner 50 and the display device 43 is performed by the power line communications in which the power line is used as a communications medium. This eliminates the need to install communications wiring lines. It is therefore possible to easily employ the electric power management system and to increase the chance of employment of the electric power management system.

(6) By providing the extension unit 68 (the first extension unit) of the power meter 29 and the subordinate extension unit 70 (the second extension unit) of the power conditioner 50 and enabling communications between the extension unit 68 and the subordinate extension unit 70, it is possible for the extension unit 68 and the subordinate extension unit 70 to exchange the power information of the power meter 29 and the power information of the power conditioner 50 with each other.

(7) The communications between the power meter 29 and the power conditioner 50 is performed by the power line communications in which the power line is used as a communications medium. This eliminates the need to install communications wiring lines. It is therefore possible to easily employ the electric power management system and to increase the chance of employment of the electric power management system.

(8) The communications between the power meter 29 and the power conditioner 50 and the communications between the power conditioner 50 and the display device 43 are performed through the power line communications in the same communications method. In other words, the communications methods of the first communications part and the second communications part are unified into the power line communications. This makes it possible to simplify the structure of the subordinate extension unit 70 of the power conditioner 50, which is included in both of the first communications part and the second communications part. This also helps reduce the effort required in installing communications equipment.

(9) The system server 61 managing the power system can acquire the power information of the power conditioner 50 to thereby estimate the power consumption trend and the like by using the power management data based on the acquired power information. For example, if the system server 61 performs the management of the power system based on the power consumption trend, it is possible to further stabilize the electric power of the power system and to increase the utility value of the electric power management system.

(10) The power conditioner 50 acquires the power information of the system server 61 from the power meter 29 and manages the power information together with the electric power inputted from and outputted to the power system. As a result, for example, if the power information of the system server 61 contains the information for stabilization of the system, the power conditioner 50 can adjust the electric power inputted to and outputted from the commercial power source, thereby stabilizing the power system. If the power information of the system server 61 contains the billing information, it is possible to perform the management of electric power according to the charged fare.

(11) The power information on the power generation amount of the solar cell 3 whose power generation pattern varies largely depending on the daytime or nighttime and the weather is managed by the power conditioner 50. It is therefore possible to efficiently perform the management of electric power by adjusting the power consumption pattern in the house having the solar cell 3.

### Second Embodiment

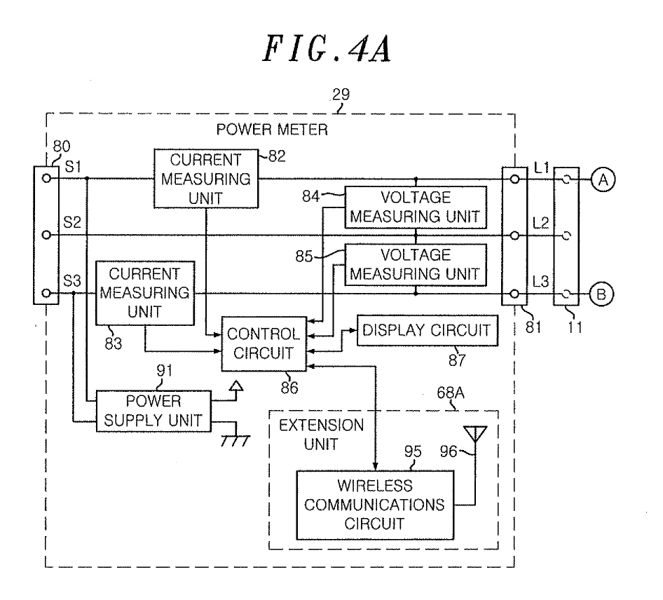

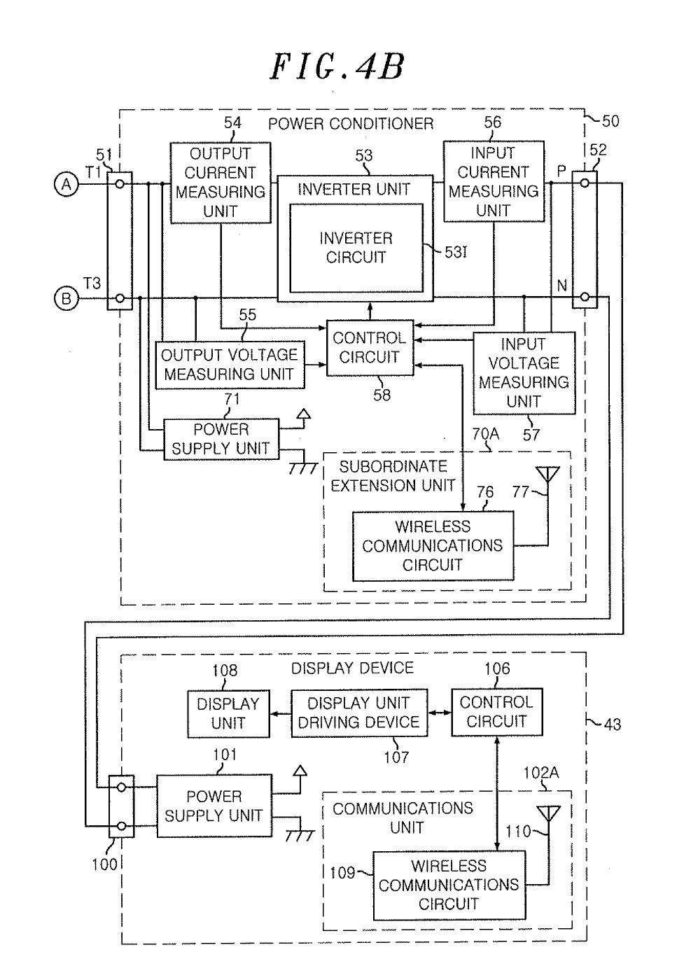

Next, an electric power management system in accordance with a second embodiment of the present invention will be described with respect to FIGS. 4A and 4B. FIGS. 4A and 4B are views schematically showing a configuration in which the communications between the power meter 29 and the power conditioner 50 and the communications between the power conditioner 50 and the display device 43 are performed through wireless communications.

The second embodiment differs from the first embodiment in that the communications between the power meter 29 and the power conditioner 50 and the communications between the power conditioner 50 and the display device 43 are performed through wireless communications. Other points remain the same as those of the first embodiment. In the present embodiment, description will be focused on the points differing from the first embodiment. Like reference numerals will be given to like parts, and redundant description thereof will be omitted for the sake of convenience.

As shown in FIGS. 4A and 4B, the power meter 29 includes current measuring units 82 and 83 for measuring the currents flowing through the terminals S1 and S3, a voltage measuring unit 84 for measuring the voltage between the terminals S1 and S2 and a voltage measuring unit 85 for measuring the voltage between the terminals S2 and S3. The measured values are inputted to a control circuit 86. The power amount calculated by the control circuit 86 is displayed on a display circuit 87.

An extension unit 68A for performing wireless communications is connected to the control circuit 86. The extension unit 68A includes a wireless communications circuit 95 and an antenna 96. The wireless communications circuit 95 receives a signal from the control circuit 86 and transmits the received signal as a wireless signal. Further, the wireless communications circuit 95 receives a wireless signal and transfers the received wireless signal to the control circuit 86.

The power meter 29 includes a power supply unit 91 for supplying the electric power required to drive the control circuit 86. The power supply unit 91 converts the electric power inputted from the terminals S1 and S3 to the electric power required to drive the control circuit 86.

Further, the power meter 29 includes a terminal block 81 having terminals L1, L2 and L3. The terminals 12 and L3 of the terminal block 81 are connected to the terminals T1 and T3 of an AC terminal block 51 of a power conditioner 50 through an AC distribution board 11.

The power conditioner 50 includes an inverter unit 53 arranged between the AC terminal block 51 and the DC terminal block 52. The inverter unit 53 has an inverter circuit 531 for performing AC-DC conversion/DC-AC conversion of the electric power between the AC terminal block 51 and the DC terminal block 52. The current and the voltage of each of the power lines connected to the terminals T1 and T3 of the AC terminal block 51 are measured by an output current measuring unit 54 and an output voltage measuring unit 55. The current and the voltage of each of the power lines connected to the terminals P and N of the DC terminal block 52 are measured by an input current measuring unit 56 and an input voltage measuring unit 57. The current and voltage values thus measured are inputted to a control circuit 58. The control circuit 58 drives and controls the inverter unit 53 based on the current and voltage values thus measured.

A subordinate extension unit 70A for performing wireless communications is connected to the control circuit 58. The subordinate extension unit 70A includes a wireless communications circuit 76 and an antenna 77. The wireless communications circuit 76 receives a signal from the control circuit 58 and transmits the received signal as a wireless signal. The wireless communications circuit 76 receives a wireless signal and transfers the received wireless signal to the control circuit 58.

Further, the power conditioner 50 includes a power supply unit 71 for supplying the electric power required to drive the control circuit 58. The power supply unit 71 converts the electric power inputted from the terminals T1 and T3 to the electric power required to drive the control circuit 58.

In the present embodiment, the extension unit 68A of the power meter 29 and the subordinate extension unit 70A of the power conditioner 50 make up a wireless communications unit as a first communications part that enables wireless communications between the power meter 29 and the power conditioner 50.

In the power conditioner 50, the terminals P and N of the DC terminal block 52 are connected to a terminal block 100 of the display device 43. The display device 43 includes a displaying unit 108 driven and controlled by a display unit driving device 107 under the control of a control circuit 106. The display device 43 further includes a communications unit 102A for performing wireless communications. The communications unit 102A includes a wireless communications circuit 109 and an antenna 110. The wireless communications circuit 109 receives a signal from the control circuit 106 and transmits the received signal as a wireless signal. The wireless communications circuit 109 receives a wireless signal and transfers the received wireless signal to the control circuit 106.

Further, the display device 43 includes a power supply unit 101 for supplying the electric power required to drive the control circuit 106. The power supply unit 101 converts the electric power inputted from the terminals P and N to the electric power required to drive the control circuit 106.

In the present embodiment, the subordinate extension unit 70A of the power conditioner 50 and the communications unit 102A of the display device 43 make up a wireless communications unit as a second communications part that enables wireless communications between the power conditioner 50 and the display device 43.

With such configuration, the extension unit 68A of the power meter 29 and the subordinate extension unit 70A of the power conditioner 50 are connected to each other such that they can make wireless communications with each other. The subordinate extension unit 70A of the power conditioner 50 and the communications unit 102A of the display device 43 are connected to each other such that they can make wireless communications with each other. The subordinate extension unit 70A of the power conditioner 50 has two communications targets, i.e., the extension unit 68A of the power meter 29 and the communications unit 102A of the display device 43. By allowing the communications targets to have different communications frequencies or by allowing the communications targets to have identification information that can identify the communications targets, it is possible for the subordinate extension unit 70A of the power conditioner 50 to make independent communications with the selected one of the communications targets.

As a result, the power information of the power meter 29 is transferred to the power conditioner 50 and is collected in the memory device 50DB of the power conditioner 50 as power-related information 50J. The power conditioner 50 controls and manages the power consumption amount of the entire power supply system 1 based on the power management data of the power-related information 50J stored in the memory device 50DB. At this time, the power conditioner 50 uses the power information of the power meter 29 coinciding with the meter reading data of the power company 60. It is therefore possible for the power conditioner 50 to more properly perform the electric power management of the entire power supply system 1.

Further, the power-related information 50J, including the power information of the power meter 29, collected in the power conditioner 50 is transferred to the display device 43 and visually displayed to a user. At this time, the power information of the power meter 29 is used to thereby display to a user the billing information on the electric power coinciding with the meter reading data of the power company 60.

As described above, the present embodiment can provide effects identical with or similar to effects (1) to (6) and (9) to (11) provided by the first embodiment that performs power line communications. In addition, the present embodiment can provide the following effects.

(12) Since the communications between the power conditioner 50 and the display device 43 is performed by wireless communications, it becomes unnecessary to install wiring lines for communications purposes. This makes it possible to increase the degree of freedom in arranging the electric power management system.

(13) Since the communications between the power meter 29 and the power conditioner 50 is performed by wireless communications, it becomes unnecessary to install wiring lines for communications purposes. This makes it possible to increase the degree of freedom in arranging the electric power management system and to facilitate use of the electric power management system.

The respective embodiments described above may be modified as follows.

In the respective embodiments described above, there is illustrated a case in which the control unit 7 and the DC distribution board 8 are included in the power conditioner 50. However, the present invention is not limited thereto. Various devices, e.g., an AC distribution board, a control box and a home server, may be included in the power conditioner 50 as long as they enables the power supply system to properly perform the management of electric power. On the contrary, the DC distribution board 8 may be excluded from the power conditioner 50. This makes it possible to increase the degree of freedom in configuring the power conditioner and to increase the chance of use of the electric power management system.

In the respective embodiments described above, there is illustrated a case in which the power conditioner 50 is provided with the memory device 50DB. However, the present invention is not limited thereto. The memory device may not be provided in the power conditioner as long as the power conditioner can manage the power information. In this case, the power information may be stored in the home server or the like so that the power conditioner can gain access thereto. This makes it possible to increase the degree of freedom in configuring the power conditioner and to increase the chance of use of the electric power management system.

In the first embodiment described above, there is illustrated a case in which the display device 43 is connected to the AC terminal block 51 of the power conditioner 50 so as to make power line communications with the power conditioner 50.

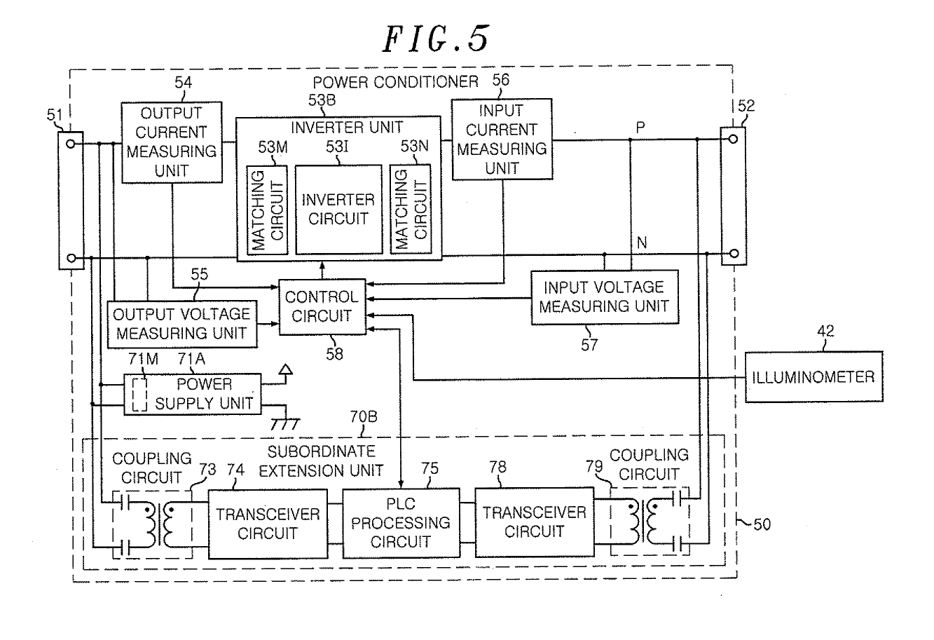

However, the present invention is not limited thereto. The display device may be connected to the DC terminal block of the power conditioner so as to make power line communications with the power conditioner 50. For example, as shown in FIG. 5, a matching circuit 53N for restraining reduction of the impedance of the power line is further provided at the DC side of the inverter circuit 531 of the inverter unit 53B of the power conditioner 50 so as to avoid reduction of the impedance between the terminals P and N of the DC terminal block 52. There are provided a transceiver circuit 78 and a coupling circuit 79 for overlapping a power line communications signal with the terminals P and N of the DC terminal block 52. The transceiver circuit 78 is connected to the power line communications processing circuit 75 for transmitting and receiving communications signals. The display device 43 is provided with a power supply unit coping with the input of DC power and having a matching circuit.

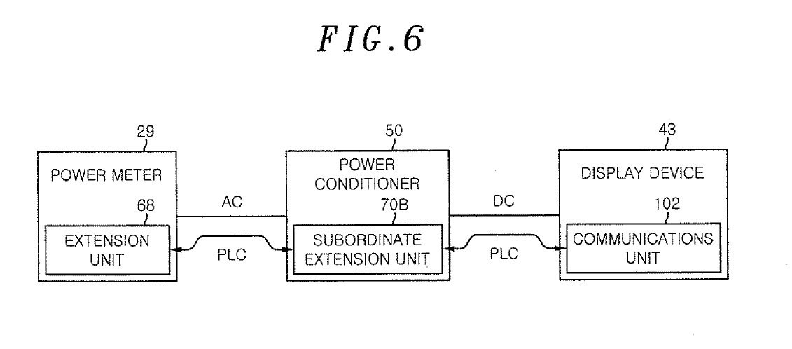

Accordingly, as shown in FIG. 6, the communications between the power meter 29 and the power conditioner 50 can be performed through the power line communications (PLC) in which a signal is conveyed by the AC power. The communications between the power conditioner 50 and the display device 43 can be performed through the power line communications (PLC) in which a signal is conveyed by the DC power.

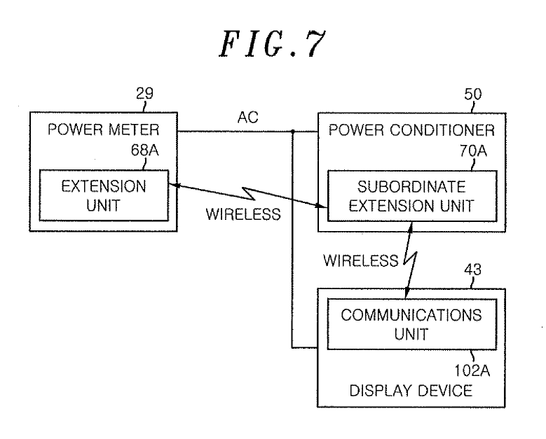

In the second embodiment, there is illustrated a case in which the DC power applied to the DC terminal block 52 of the power conditioner 50 is used as the source power of the display device 43. However, the present invention is not limited thereto. The source power of the display device 43 may be AC power and the power conditioner 50 may make wireless communications. As shown in, e.g., FIG. 7, it is therefore possible to provide a combination in which the communications between the power meter 29 and the power conditioner 50 and the communications between the power conditioner 50 and the display device 43 are performed by wireless communications and in which AC power is used as the source power of the power meter 29, the power conditioner 50 and the display device 43.

In the respective embodiments described above, there is illustrated a case in which the power-related information 50J of the power conditioner 50 is displayed by the display device 43. However, the present invention is not limited thereto. If recognizable by a user, the power-related information of the power conditioner may be provided in the form of an image or a voice through a device having a user interface, such as an operation panel 40, a door phone extension unit or a television set, each of which is communicatively connected to the power conditioner 50. This makes it possible to increase the degree of freedom in configuring the electric power management system.

In the respective embodiments described above, there is illustrated a case in which the power meter 29 makes communications with the system server 61. However, the present invention is not limited thereto. The power meter may be allowed to make communications with a different base unit through the base unit installed in the electric pole. That is, the power meter makes communications with a different power meter through the base unit, which makes it possible for the power conditioner of the power meter to acquire the information of a power conditioner of the different power meter.

For example, seven to ten houses are connected to step-down transformers. Base units are provided in a corresponding relationship with every step-down transformer or some of the step-down transformers. In this case, the power meter can make communications through the base unit with another power meter connected to the step-down transformer corresponding to the base unit. This makes it possible to make interactive communications through the power meter in a limited area. For example, the information on the availability of electric power can be exchanged between the adjoining power conditioners. This configuration can also be used in transferring various kinds of information, which is not directly related to the electric power, such as the notice information and the crime prevention information.

In the respective embodiments described above, there is illustrated a case in which the subordinate extension unit 70 of the power conditioner 50 is used as both the second extension unit of the first communications part and the subordinate extension unit of the second communications part. However, the present invention is not limited thereto. The second extension unit for the first communications part and the subordinate extension unit for the second communications part may be independently provided in the power conditioner. This makes it possible to increase the degree of freedom in performing communications between the power conditioners.

In the respective embodiments described above, there is illustrated a case in which the solar cell 3 is used as a power generating device. However, the present invention is not limited thereto. The power generating device may be other devices having a power generating function, such as a battery, a fuel cell and a wind power generation device.

While the invention has been shown and described with respect to the embodiments, it will be understood by those skilled in the art that various changes and modification may be made without departing from the scope of the invention as defined in the following claims.

1. An electric power management system, comprising:
a power meter connected to a power system of a commercial power source; and
a power conditioner connected to the power meter, a power generating device and an electric appliance,
wherein the power meter and the power conditioner exchange power information through a communications part at a side of the power meter.

2. The electric power management system of claim 1, wherein the power meter is connected to the power system of the commercial power source to acquire power information from an electric power inputted from the power system and an electric power outputted to the power system,
wherein the power conditioner is configured to collect power information of the power generating device; power information of the electric appliance; and the power information on the electric power inputted from the power system and the power information on the electric power outputted to the power system, which are acquired from the power meter through the communications part at the side of the power meter, and to manage the electric power inputted from the power system and the electric power outputted to the power system, based on the collected power information.

3. The electric power management system of claim 2, further comprising:
a display device for acquiring the power information collected in the power conditioner from the power conditioner through a communications part at a side of the display device and visually displaying the acquired power information on a display unit.

4. The electric power management system of claim 3, wherein the communications part at the side of the display device includes a subordinate extension unit provided in the power conditioner to transmit the power information collected in the power conditioner and a communications unit provided in the display device to receive the power information transmitted from the subordinate extension unit.

5. The electric power management system of claim 4, wherein the communications part at the side of the power meter includes a first extension unit provided in the power meter to transmit the power information acquired from the power meter and a second extension unit provided in the power conditioner to receive the power information transmitted from the first extension unit.

6. The electric power management system of claim 5, wherein the second extension unit of the power conditioner serves as the subordinate extension unit of the corresponding power conditioner.

7. The electric power management system of claim 2, wherein the power meter further includes a device communicatively connected to a system server for managing the power system of the commercial power source and configured to acquire the power information collected in the power conditioner through the communications part at the side of the power meter and transfer the acquired power information to the system server.

8. The electric power management system of claim 7, wherein the power conditioner is configured to acquire power information held by the system server through the power meter and to manage the acquired power information.

9. The electric power management system of claim 3, wherein the power meter further includes a device communicatively connected to a system server for managing the power system of the commercial power source and configured to acquire the power information collected in the power conditioner through the communications part at the side of the power meter and transfer the acquired power information to the system server.

10. The electric power management system of claim 4, wherein the power meter further includes a device communicatively connected to a system server for managing the power system of the commercial power source and configured to acquire the power information collected in the power conditioner through the communications part at the side of the power meter and transfer the acquired power information to the system server.

11. The electric power management system of claim 5, wherein the power meter further includes a device communicatively connected to a system server for managing the power system of the commercial power source and configured to acquire the power information collected in the power conditioner through the communications part at the side of the power meter and transfer the acquired power information to the system server.

12. The electric power management system of claim 6, wherein the power meter further includes a device communicatively connected to a system server for managing the power system of the commercial power source and configured to acquire the power information collected in the power conditioner through the communications part at the side of the power meter and transfer the acquired power information to the system server.

13. The electric power management system of claim 9, wherein the power conditioner is configured to acquire power information held by the system server through the power meter and to manage the acquired power information.

14. The electric power management system of claim 10, wherein the power conditioner is configured to acquire power information held by the system server through the power meter and to manage the acquired power information.

15. The electric power management system of claim 11, wherein the power conditioner is configured to acquire power information held by the system server through the power meter and to manage the acquired power information.

16. The electric power management system of claim 12, wherein the power conditioner is configured to acquire power information held by the system server through the power meter and to manage the acquired power information.
